(19) United States
(12) Patent Application Publication
(10) Pub. No.: US 2024/0045015 A1
(43) Pub. Date: Feb. 8, 2024

(54) UPLINK-BASED AND DOWNLINK-BASED POSITIONINGS

(71) Applicant: NOKIA TECHNOLOGIES OY, Espoo (FI)

(72) Inventors: Tao TAO, Shanghai (CN); Benny VEJLGAARD, Gistrup (DK); Daejung YOON, Massy (FR); Ryan KEATING, Chicago, IL (US); Dong LI, Shanghai (CN)

(73) Assignee: NOKIA TECHNOLOGIES OY, Espoo (FI)

(21) Appl. No.: 18/258,871

(22) PCT Filed: Dec. 22, 2020
(86) PCT No.: PCT/CN2020/138199

§ 371 Date: Jun. 22, 2023

(51) Int. Cl. G01S 5/02; G01S 5/14

(52) U.S. Cl. CPC G01S 5/0244; G01S 5/0236; G01S 5/145; G01S 2205/008

(57) ABSTRACT

Embodiments of the present disclosure relate to UL-based and DL-based positioning in a wireless communication network. A method comprises: determining, by a first device, an estimation of a propagation delay for a first reference signal to be transmitted from a second device; in accordance with a determination that the estimation of the propagation delay exceeds a threshold delay, determining a target period within a symbol on which at least a part of the first reference signal is transmitted; and performing positioning measurements on the first reference signal within the target period. As such, the receiver is capable of applying an adaptive and adjustable window for receiving different positioning reference signals (PRSs) depending on various conditions and situations. In this way, the PRS measurement performance and the positioning accuracy can be greatly improved.

### FIELD

Embodiments of the present disclosure generally relate to the field of telecommunication and in particular, to methods, devices, systems, apparatuses, and computer readable storage media for uplink (UL)-based and downlink (DL)-based positioning.

### BACKGROUND

With the development of communication technology, carrier frequencies have been above 52.6 GHz, even up to 71 GHz. Such higher carrier frequencies are attractive for positioning devices in a wireless communication network, as higher bandwidths are available for transmission of signal, for example, a positioning reference signal (PRS). The higher bandwidths lead to a better achievable timing estimation, which may in turn lead to a higher positioning accuracy.

For the fifth-generation new radio communication network, also referred to as 5G NR, the Orthogonal Frequency Division Multiplexing (OFDM) technology is very likely to be reused on these carrier frequencies, and may introduce a higher subcarrier spacing (SCS). The high SCS may be increased from 240 kHz to 960 kHz or an even higher SCS. Along with the SCS increases, an OFDM symbol length and a cyclic prefix (CP) length will become shorter. From the point of view of a terminal device (e.g., UE), this may break down the symbol alignment of the PRSs received from neighbor gNBs that are far away from the terminal device. Hence, there is a demand for an enhanced UL-based and/or DL-based positioning scheme adaptive to different system numerologies.

### SUMMARY

In general, example embodiments of the present disclosure provide a method, devices, systems, apparatuses, and computer readable storage media for UL-based and DL-based positioning.

In a first aspect, there is provided a first device. The first device comprises at least one processor and at least one memory including computer program code. The at least one memory and the computer program code configured to, with the at least one processor, cause the first device to: determine an estimation of a propagation delay for a first reference signal to be transmitted from a second device; in accordance with a determination that the estimation of the propagation delay exceeds a threshold delay, determine a target period within a symbol on which at least a part of the first reference signal is transmitted; and perform positioning measurements on the first reference signal within the target period.

In a second aspect, there is provided a method of communications. The method comprises: determining, by a first device, an estimation of a propagation delay for a first reference signal to be transmitted from a second device; in accordance with a determination that the estimation of the propagation delay exceeds a threshold delay, determining a target period within a symbol on which at least a part of the first reference signal is transmitted; and performing positioning measurements on the first reference signal within the target period.

In a third aspect, there is provided a communication system. The communication system comprises a first device according to the above first aspect.

In a fourth aspect, there is provided a first apparatus of communications. The first apparatus comprises: means for determining an estimation of a propagation delay for a first reference signal to be transmitted from a second apparatus; means for in accordance with a determination that the estimation of the propagation delay exceeds a threshold delay, determining a target period within a symbol on which at least a part of the first reference signal is transmitted; and means for performing positioning measurements on the first reference signal within the target period.

In a fifth aspect, there is provided a non-transitory computer readable medium comprising program instructions for causing an apparatus to perform the method according to the above first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication system in which embodiments of the present disclosure may be implemented;

FIG. 2 illustrates a schematic diagram of an example comb structure of PRSs in the frequency domain according to some example embodiments of the present disclosure;

FIG. 3 illustrates a schematic diagram of an original period of a legacy window and a target period of an adaptive window for receiving PRSs according to some example embodiments of the present disclosure;

FIG. 4 illustrates a flowchart of a method of communications in accordance with some example embodiments of the present disclosure;

FIG. 5 illustrates a signaling flow for DL-based positioning in accordance with some example embodiments of the present disclosure;

FIG. 6 illustrates a signaling flow for UL-based positioning in accordance with some example embodiments of the present disclosure;

FIG. 7 illustrates a simplified block diagram of an apparatus that is suitable for implementing embodiments of the present disclosure; and

FIG. 8 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “some example embodiments,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with some example embodiments, it is submitted that it is within the knowledge of one skilled in the art to affect such feature, structure, or characteristic in connection with other embodiments whether or not explicitly described.

It shall be understood that although the terms “first”, “second”, “third”, “fourth”, and etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Non-terrestrial network (NTN), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems, including but not limited to a terrestrial communication system, a non-terrestrial communication system or a combination thereof. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Multiple positioning technologies can be used for positioning the terminal device in a wireless communication network, such as, DL-based and UL-based Time Difference of Arrival (TDOA), DL-based Angle of Departure (AoD), UL-based Angle of Arrival (AoA), multi-Round-Trip time (Multi-RTT), and so on. Taking the DL-based positioning technology as an example, the location of the terminal device may be determined based on DL measurements on a plurality of PRSs transmitted from its serving cell and at least one neighboring cell. The time-frequency resources in DL are allocated for different reference signals from different network devices based on a comb structure. Specifically, according to the comb structure, different comb offsets are assigned to different base stations in order to orthogonalize the signals transmitted from those base stations in the frequency domain. There are various comb sizes that can be chosen from a set {2, 4, 6, 12} by a higher layer configuration. In measuring more than one PRS from multiple base stations, the terminal device applies a single window for receiving PRSs on each OFDM symbol in the time domain. Typically, the window for receiving the PRSs may be an original receiving window based on the timing of the serving cell of the terminal device.

In a case of transmission of signals at higher carrier frequencies, for example, up to 52.6 GHz or even higher, the SCS will increase, which in turn results in shorter symbol length and CP length. From the UE's point of view, the symbol for transmission of a PRS from a neighbor base station that is far away from the UE may not be aligned with the symbol for transmission of a PRS from its serving cell. This is mainly due to the fact that a propagation delay is not negligible any more, that is, the propagation delay is no longer much small than the CP length at higher carrier frequencies. In this case, the PRSs received from different base stations on the same symbol with the original receiving window may cause additional interferences to neighboring symbols.

For LTE/NR systems, there are two modes of CP configurations for OFDM symbols, that is, a normal CP length and an extended CP length. The extended CP has a longer length than the normal CP, and thus a total symbol length also gets longer. If inter-symbol interferences from the long propagation delay is expected, numerologies of the communication system may configure an extended CP to capture the long propagation delay. However, the switching of CP mode may be challenging and has several limitations. For example, the extended CP mode is merely supported by, such as, the single frequency network (SFN). The change of CP modes impacts the slot format at a symbol level and degrades the transmission efficiency. Also, if the two modes are mixed across cells, the cells may produce interferences to each other.

In order to solve the above and other potential problems, embodiments of the present disclosure provide an enhanced DL-based and/or UL-based positioning scheme with an adaptive and flexible period for receiving PRSs. More specifically, a receiver, which is the UE in the DL case and a base station in the UL case, is capable of applying different window-width for receiving respective PRSs from different transmitter. Several factors can be taken into considerations in determining the receiving window, such as, an estimated propagation delay associated with the transmitter, the distance between the transmitter and the receiver, qualities of PRSs, PRS configurations, and so on.

By means of the adaptive and adjustable receiving window, the UL-based and DL-based positioning scheme provided in the example embodiments of the present disclosure is suitable for various network conditions and situations. In this way, the PRS measurement performance and the positioning accuracy can be greatly improved, while introducing less interference at the frequency band, especially for the higher frequency bands.

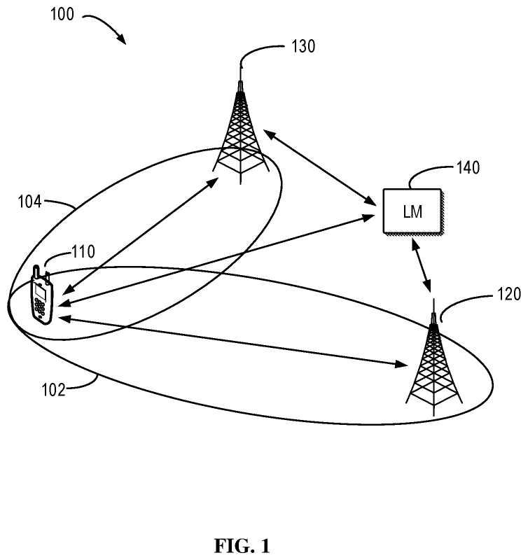

Principle and embodiments of the present disclosure will be described in detail below with reference to the accompanying drawings. Reference is first made to FIG. 1, which illustrates an example communication system 100 in which example embodiments of the present disclosure may be implemented.

As shown in FIG. 1, the communication system 100, which may be a part of a communication network, includes a terminal device 110, a network device 120 that provides a neighbor cell 102 of the terminal device 110, a network device 130 that provides a serving cell 104 of the terminal device 110, and a location management (LM) device 140. Although the network device 110 is shown as a UE, and the network devices 120 and 130 are shown as base stations, it is to be understood that embodiments of the present disclosure are also applicable to any other suitable implementations.

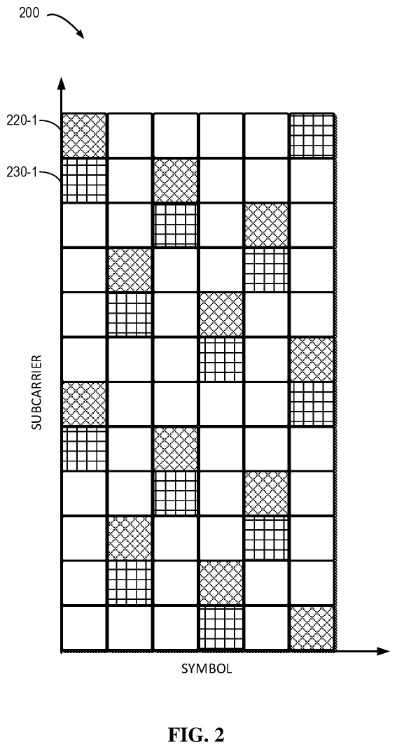

The terminal device 110 may communicate with the network devices 120 and 130 via DL and UL channels. In the context of the example embodiments of the present disclosure, the network device 120 is described as a neighbor base station, and the network device 130 is described as a base station that serves the terminal device 110. The terminal device 110 may receive and measure respective reference signals (e.g., the PRSs) from the network devices 120 and 130. The terminal device 110 may then transmit the measurement result to the LM device 140 for positioning. As previously mentioned, the reference signals from different network devices may be transmitted on a set of PRS resources which are allocated based on the comb structure. The comb structure has a predetermined comb size and a comb offset, which will be discussed below in connection with FIG. 2.

The LM device 140 may be, for example, a location server or any other device implementing a location management function, and deployed in the RAN, the core network or over the cloud. The LM device 140 may collect and store PRS configurations and positioning assistance data from the core network and the radio access network (RAN). In addition, the LM device 140 may determine the location of the terminal device 110 based on the measurements received from the terminal device 110 and/or the network device 120.

The PRS configurations may include, but not limited to the comb size and offset for PRS in the frequency domain, muting patterns of the network devices 120 and 130, transmitter (Tx) beam patterns, a receiver beam pattern, quasi co-location of the PRSs and so on. The positioning assistance data may include, for example, a location of the network device 120, a location of the network device 130, a distance between the network device 120 and the network device 130, a diameter of the serving cell 104 or expected RSTD and uncertainty information, and so on.

As one implementation of the present disclosure, for example, in the DL-based positioning solution, the terminal device 110 acts as a receiver, while the network device 120 and 130 act as transmitters. In this case, the terminal device 110 may be referred to as a first device, the network device 120 may be referred to as a second device, and the network device 130 may be referred to as a third device.

As another implementation of the present disclosure, for example, the UL-based positioning solution, the terminal device 110 acts as a transmitter, while the network device 120 acts as a receiver. In this case, the network device 120 may be referred to as the first device, and the terminal device 110 may be referred to as a second device.

It is to be understood that the communication system 100 may include any suitable number of network devices and/or terminal devices as well as additional elements not shown adapted for implementations of the present disclosure, without suggesting any limitation as to the scope of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Reference is now made to FIG. 2, which illustrates a schematic diagram of an example comb structure 200 for PRSs in DL according to some example embodiments of the present disclosure. It is to be appreciated that such a comb structure is also suitable for transmission of signals in UL, and the implementations in UL is omitted herein for sake of brevity. For the purpose of discussion, the comb structure 200 will be described with reference to FIG. 1.

According to the comb structure, the comb sizes in the time domain can be chosen by the higher layer configuration from a set {2, 4, 6, 12} and different comb offsets are allocated to different base stations in order to orthogonalize PRSs in the frequency domain. Specifically, as shown in FIG. 2, the PRS resources for DL PRSs are mapped based on comb 6 and 2 base stations, with blocks in diamond pattern (e.g., the block 230-1) represents the PRS resources allocated for transmission of a first reference signal from the network device 120, and the blocks in grid pattern (e.g., the block 230-1) represents the PRS resources allocated for transmission of a second reference signal from the network device 130. The first reference signal and the second reference signal may be collectively referred to as PRSs. It should be understood that the first and second reference signals may be any other signal suitable for positioning. The scope of the present disclosure is not limited in this aspect.

From the perspective of a terminal device, a receiving window of a fixed duration (e.g., one symbol) is applied to measure respective PRSs transmitted from different network devices in a legacy communication system. The duration and the starting point of such a receiving window are typically determined based on the timing of the serving cell of the terminal device. In the example embodiments of the present disclosure, the duration and the starting point of the receiving window can be adaptive and adjustable based on several factors and the situations in the communication system 100.

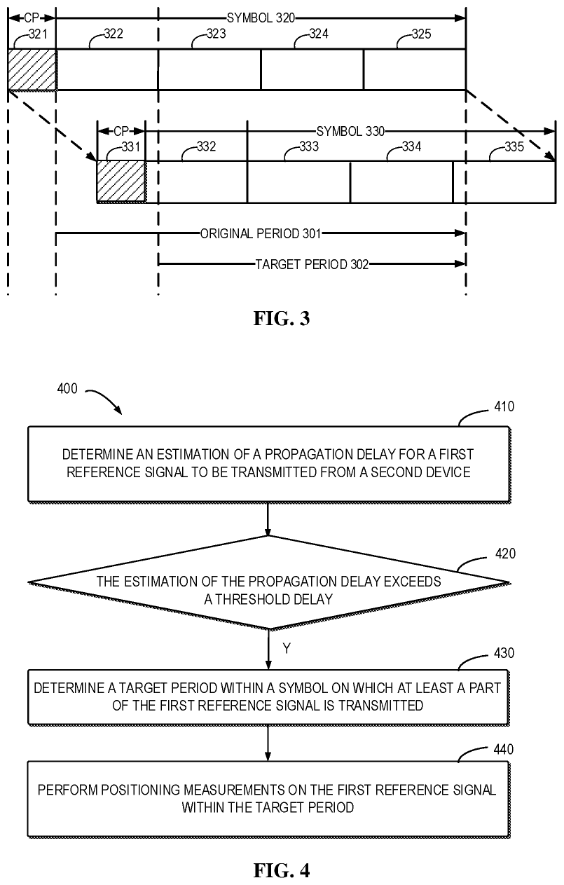

FIG. 3 illustrates a schematic diagram of an original period 301 of a legacy window and a target period 302 of an adaptive window for receiving PRSs according to some example embodiments of the present disclosure. For the purpose of discussion, the example durations of the legacy window and the adaptive window will be described with reference to FIGS. 1 and 2.

The SCS may increase as the carrier frequency becomes higher. Along with the SCS increases, the length of an OFDM symbol as well as the length of CP are getting shorter. In this case, the symbol alignment of PRS resources allocated for a neighbor base station (e.g., the network device 120) far away from the terminal device 110 may be broken down, as shown in FIG. 3. This is primarily due to the fact that the propagation delay for transmission of a reference signal from a remote network device cannot be negligible. The propagation delay for transmission of the first reference signal from the network device 120 may exceed the length of CP at a high carrier frequency. If the terminal device 110 still receives the first reference signal and the second reference signal on the same symbol with the original period 301 of the legacy window corresponding to the serving cell 104, additional interferences are introduced to neighboring symbols, which may degrade the positioning performance of the communication system 100.

In legacy communication systems, for example, a LTE or NR system, there are two modes of CP configurations for a OFDM symbol, namely, a normal CP length and an extended CP. The extended CP has a longer length than the normal CP, and a total length of the symbol gets longer accordingly. If inter-symbol interferences due to a long propagation delay are expected, system numerologies may configure the extended CP to capture the long propagation delay. On the other hand, the use case of the extended CP mode is limited such as single frequency network (SFN). Further, the change of CP mode impacts a slot format at a symbol level, and the extended CP length may degrade the transmission efficiency of the reference signals. Also, if the two modes are mixed across a plurality of cells, the cells will interfere to each other.

Continuing to refer to FIG. 3, the first reference signal transmitted on PRS resources with the comb structure in frequency domain includes multiple repetitions 322 to 325 in the time domain. Each of the repetitions 322 to 325 contains all information carried in the first reference signal. Likewise, the second reference signal includes multiple repetitions 332 to 335 in the time domain. Each of the repetitions 332 to 335 contains all information of the second reference signal. From the perspective of the receiver, receiving only some of repetitions may lead to SNR degradation, while receiving too many repetitions may introduce additional interferences. Hence, there is a need for an adaptive window for receiving the PRSs.

According to the example embodiments of the present disclosure, an adaptive window is proposed for PRS reception. The target period of the adaptive window can vary from different situations for PRS reception. Specifically, the target period 302 of the adaptive receiving window can be determined based on various factors, which will be discussed in details below.

Principle and embodiments of the present disclosure will be described in detail below with reference to FIGS. 4 to 6. In order to implement an enhanced DL-based and UL-based positioning in a wireless communication network, the embodiments of the present disclosure provide an adaptive window for receiving and measuring positioning signals. FIG. 4 illustrates a flowchart of a method 400 of communications in accordance with some example embodiments of the present disclosure. The method 400 can be implemented at the first device acting as the receiver, e.g., at the terminal device 110 or the network device 120 as shown in FIG. 1. For the purpose of discussion, the method 400 will be described in connection with FIG. 1.

At block 410, the first device determines an estimation of a propagation delay for the first reference signal to be transmitted from the second device. In a case where the first device is the terminal device 110, and the second device is the network device 120 that provides the neighbor cell 102 of the terminal device 110, the estimation of the propagation delay may be a time offset of a first receipt time of the first reference signal relative to a second receipt time of the second reference signal from the neighbor cell 102 of the terminal device 110.

In some example embodiments, the estimation of the propagation delay may be determined based on a distance between the first device and the second device. In the above case where the first device is the terminal device 110, the second device is the network device 120, and the third device is the network device 130 that provides the serving cell 104 of the terminal device 110, the distance between the first device and the second device may be determined based on at least one of the prior location of the first device and positioning assistance data, which may be obtained from the LM device 140 or any other suitable device. The positioning assistance data may include, but not limited to, the location of the second device, the location of the third device, the distance between the second device and the third device, a diameter of the serving cell 104 or expected RSTD and uncertainty information, and the like.

In a case where the first device is the network device 120, a third device is the network device 130 that provides a neighbor cell 102 of the first device, and the second device is the terminal device 110 served by the network device 130, the distance between the first device and the second device may be determined based on one or more of the comb structure of PRSs including the first reference signal in the frequency domain, the prior location of the second device and positioning assistance data. In this case, the positioning assistance data may include, but not limited to, one or more of the location of the first device, the location of the third device, the distance between the first device and the third device and the like.

In some example embodiments, the estimation of the propagation delay may be determined based on receiving timing of a further reference signal, for example, synchronization signal block (SSB) from the second device. In such embodiments, the first device is the terminal device 110, and the second device is a network device 120 that provides a neighbor cell 102 of the terminal device 110.

At block 420, the first device determines whether the estimation of the propagation delay exceeds a threshold delay. In some example embodiments, the threshold delay may be determined based on one of the length of the cyclic prefix of the symbol or a predefined duration.

If the estimation of the propagation delay exceeds the threshold delay, at block 430, the first device determines a target period within a symbol on which at least a part of the first reference signal is transmitted. In some example embodiments, the target period may be determined based on one or more of the estimation of the propagation delay, a quality of the first reference signal and the comb structure of PRSs including the first reference signal in the frequency domain.

In some other example embodiments, the first device may first determine a candidate period within the symbol based on the estimation of the propagation delay and the comb structure of PRSs in the frequency domain. Then, the first device may determine the target period based on the candidate period and a quality of the first reference signal. In the context of the embodiments of the present disclosure, the PRSs include the first reference signal and selectively the second reference signal.

In order to determine the candidate period, the first device may determine an effective portion of the first reference signal based on the estimation of the propagation delay and the comb structure. In some example embodiments, the effective portion may be an inter-symbol-interference (ISI) free portion of the first reference signal within the symbol, which includes at least one of the repetitions in the first reference signal, and each of the repetitions contains all information carried in the first reference signal. It should be understood that, the use of the terms “the inter-symbol-interference free portion” and “ISI-free” in the embodiments of the present disclosure is not intended to restrict the reference signals described in the embodiments to be without any ISI at all, or with a ISI-free level up to 100%. Rather, such terms indicate that the reference signal can be regarded as having the very few ISI.

In some example embodiments, the quality of the first reference signal may be determined based on a PRS configuration, which may include, but not limited to, a muting pattern and a transmitter beam pattern of the second device, a receiver beam pattern of the first device, or quasi co-location information of the first reference signal and so on.

In some other example embodiments, the quality of the first reference signal may be determined based on one or more parameters related to signal quality. The parameters related to signal quality may include, but not limited to, RSRP, RSRQ, RSSI, SNR of the first reference signal and any other parameter indicative of the quality of the PRS. The scope of the present disclosure is not limited to this aspect.

In some example embodiments, the first device may determine whether the quality of the first reference signal indicates that the first reference signal is dominated by noises or interferences. If the quality of the first reference signal indicates that a noise level dominating in the first reference signal, the first device may determine the target period by extending the candidate period. For example, the target period may be determined by including more repetitions than that of the candidate period, and the target period may or may not correspond to an integer multiple of the repetitions (e.g., 1.8 repetitions), as long as all the information carried by the first reference signal is included.

In other words, the first device may increase the candidate period to boost the SNR of the first reference signal received from the second device. Otherwise, if the quality of the first reference signal indicates that an interference level is dominated in the first reference signal, the first device may determine that there is no need to extend the candidate period. In this case, the first device may determine the target period by comprising at least a part of the candidate period.

In some example embodiments, the first device may determine whether the quality of the first device is below a threshold quality. If the quality of the first device is below a threshold quality, the first device may determine the target period by extending the candidate period, so as to receive more repetitions within the target period. Otherwise, if the quality of the first reference signal exceeds the threshold quality, the first device may determine that there is no need to extend the candidate period. In this case, the first device may determine the target period by comprising at least a part of the candidate period.

At block 440, the first device performs positioning measurements on the first reference signal within the target period. In some example embodiments, the first device may receive the part of the first reference signal rather than a complete first reference signal based on the target period. For example, the first device may filter the received signal samples based on the target period, that is, the adaptive receiving window. In these embodiments, the first device may perform the positioning measurements on the part of the first reference signal.

In some other example embodiments, the first device may receive the entire first reference signal from the second device. The first device may then determine the part of the first reference signal based on the target period, and perform the positioning measurements on the part of the first reference signal.

In some example embodiments, the first device may determine an updated size of a time-frequency transformation size based on the target period. The time-frequency transformation size may be the FFT size. For example, the FFT size may be switched from 2048 to 512. In this case, the first device may perform the positioning measurements based on the updated size of the time-frequency transformation.

In some example embodiments, the first device may transmit the positioning measurements to the LM device 140 for positioning the location of the first device. According to example embodiments, the first device may be one of the terminal device 110 (e.g., the UE) and the network device 120 (e.g., the gNB), and the second device may be the other one of the terminal device 110 (e.g., the UE) and the network device 120 (e.g., the gNB).

It should be understood that a part of all of the steps 410 to 430 may be repeatedly performed for more than one time within a single PRS occasion in a symbol-to-symbol manner. Alternatively, the above steps 410 to 430, either alone or in combination, may be repeatedly performed across PRS occasions in a subframe-to-subframe manner.

According to the example embodiments of the present disclosure, there is provided an adaptive window for receiving PRSs suitable for both the UL-based and DL-based positioning. The solution allows the adaptive receiving window by taking the channel characteristics, the PRS muting pattern, the beam management, and etc. into account, without increasing the system complexity. The receiving window can be adjustable to adapt to different network conditions (e.g., various carrier frequencies) and different combinations of base stations. Therefore, the PRS measurement performance and the positioning accuracy can be significantly improved with less interference introduced to the frequency band.

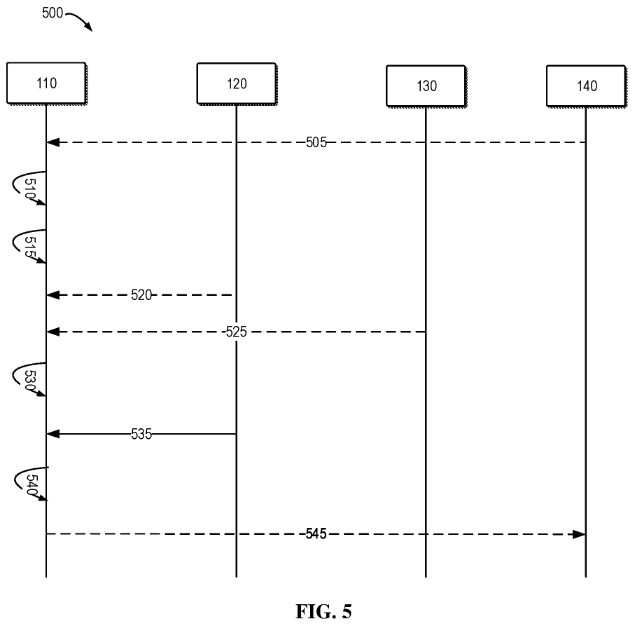

FIG. 5 illustrates a signaling flow 500 for DL-based positioning in accordance with some example embodiments of the present disclosure. The process 500 is provided as one of the implementations in DL of the method 400 shown in FIG. 4. Thus, in the description of the process 500, the first device is the terminal device that receives and measures the reference signals and the second device is the network device that provides the neighbor cell of the terminal device. For the purpose of discussion, the process 500 will be described with reference to FIG. 1 in which the terminal device 110 acts as the first device, the network device 120 acts as the second device and the network device 130 acts as the third device. The process 500 may further involve the LM device 140 in FIG. 1.

The terminal device 110 may obtain 405 the prior location of the terminal device 110 and positioning assistance data from the LM device 140. In some example embodiments, the positioning assistance data may include one or more of the location of the network device 120 that acts as the transmitter of the first reference signal, the location of the network device 130 that provides the serving cell 104 of the terminal device 110, the distance between the network device 120 and the network device 130, a diameter of the serving cell 104, and expected RSTD and uncertainty information. The expected RSTD and uncertainty information may be indicated by the LM device 140 based on pre-knowledge on geographical information (e.g., cell-to-cell distance).

The terminal device 110 determines 510 an estimation of a propagation delay for the first reference signal to be transmitted from the network device 120. The estimation of the propagation delay may be determined based on a rough distance between the terminal device 110 and the transmitter of the first reference signal, namely, the network device 120. In some example embodiments, the rough distance may be determined based on the prior location of the terminal device 110, for example, in a case where the terminal device 110 is stationary or in low mobility. In addition, or alternatively, the rough distance may be determined based on the positioning assistance data obtained from the LM device 140.

In some example embodiments, the estimation of the propagation delay in 510 may be determined based on a receiving timing of a further reference signal from the network device 120, such as, a synchronization signal block (SSB) that is configured as QCL source.

In some example embodiments, the estimation of the propagation delay in 510 may be a time offset of a first receipt time at which the first reference signal is received from the network device 120 relative to a second receipt time at which a second reference signal is received from the network device 130.

The terminal device 110 determines 515 whether the estimation of the propagation delay exceeds a threshold delay. The threshold delay is configured for determining whether the estimation of the propagation delay is so large that may cause a misalignment of the symbol on which the first reference signal is received and the original receiving window 301 of the terminal device 110. In other words, the threshold delay indicates a tolerance of timing synchronization misalignment between the receiver (i.e., the first device) and the transmitter (i.e., the second device). In some example embodiments, the threshold delay may be determined based on the length of the CP of the symbol or a predefined duration.

If the estimation of the propagation delay exceeds the threshold delay, it may indicate that the network device 120 is far away from the terminal device 110, and the symbol alignment of PRB resources for the first reference signal cannot be reached. In this case, performing measurements (e.g., ToA, and so on) on the original receiving window 301 may lead to a degradation of SNR and a reduction of the positioning accuracy. In some embodiments, if the terminal device 110 determines that the estimation of the propagation delay exceeds the threshold delay in 515, the terminal device 110 determines 530 a target period within a symbol on which at least a part of the first reference signal is transmitted. In the context of the present disclosure, the target period may be also referred to a target receiving window.

Alternatively, in the case where the estimation of the propagation delay is indicated by the time offset, the terminal device 110 may receive 520 the first reference signal from the network device 120 at the first receipt time, and receive 525 the second reference signal from the network device 130 at the second receipt time. The terminal device 110 may then determine the time offset based on a difference between the first and second receipt times.

In some example embodiments, the terminal device 110 may determine the target period based on one or more of the following factors: the estimation of the propagation delay, a quality of the first reference signal and a comb structure of PRS including the first reference signal in the frequency domain, and so on.

In addition, or alternatively, to determine the target period in 525, the terminal device 110 may first determine a candidate period within the symbol based on the estimation of the propagation delay and the comb structure of PRSs in the frequency domain. By way of example, the candidate period may be determined by comparing the estimation of the propagation delay and the slot/symbol structure of the serving cell 104. The candidate period corresponds to an effective portion of the first reference signal within an OFDM symbol.

In some example embodiments, the effective portion may be an inter-symbol-interference free portion of the first reference signal within the symbol based on a comb structure of the PRS and the estimation of the propagation delay. The inter-symbol-interference free portion of the first reference signal includes at least one of the time-frequency repetitions in the first reference signal, and each of the repetitions contains all information carried in the first reference signal. In some other example embodiments, the terminal device 110 may use multiple Fast Fourier Transformations (FFTs) with different repetitions to compare the interference level. It is to be understood that the candidate period may or may not correspond to an integer multiple of the repetitions (e.g., 1.5 repetitions), as long as all the information carried by the first reference signal is included.

After determining the candidate period, the terminal device 110 may then determine the target period based on the candidate period and the quality of the first reference signal. The quality of the first reference signal may be indicated by a fact that whether the first reference signal is dominated by noises or interferences. In some example embodiments, this can be determined from the estimation of the propagation delay. For example, if the estimation of the propagation delay indicates that the network device 120 is far away from the terminal device 110, the first reference signal is very likely to be dominated by noises. Otherwise, if the estimation of the propagation delay indicates that the network device 120 is in proximity of the terminal device 110, the first reference signal may be dominated by interferences.

In some other example embodiments, the quality of the first reference signal may be determined based on a PRS configuration, which includes, but not limited to, a muting pattern and a transmitter beam pattern of the network device 120, a receiver beam pattern of the terminal device 110, and quasi co-location information of the first reference signal. For example, if the network device 120 close to the terminal device 110 is muted, the first reference signal may be regarded as dominated by noises; otherwise, the first reference signal may be regarded as dominated by interferences. For another example, the receiver beam chosen by the terminal device 110 may improve the link to the network device 120, while degrade the link to another network device, for example, the terminal device 130.

In still other example embodiments, the quality of the first reference signal may be determined based on parameters related to signal quality. Such parameters may include, for example, the reference signal received powers (RSRP) of the PRSs, the reference signal receiving qualities (RSRQ) of the PRSs, the received signal strength indicator (RSSI) of the PRSs, the signal to noise ratios (SNR) of the PRSs. For example, the terminal device 110 is configured with the Tx power of PRSs and thus it may determine whether the PRSs are dominated by noises or interferences based on the RSRP of the PRSs.

Still referring to FIG. 5, if the quality of the first reference signal indicates that a noise level dominating in the first reference signal, in 530, the terminal device 110 may determine the target period by extending the candidate period. In this way, the SNR of the first reference signal is boosted. Otherwise, if the quality of the first reference signal indicates that an interference level dominating in the first reference signal, the terminal device 110 may consider the candidate period as the target period. In other words, the candidate period is determined to be the target period without any adjustment. It is to be understood that various ways of adjusting the candidate period to determine the target period are suitable to the example embodiments, and thus the scope of the present disclosure is not limited in this aspect.

Alternatively, in some other example, if the quality of the first reference signal is below a threshold quality, the terminal device 110 may determine the target period by extending the candidate period to receive more repetitions in the symbol. Otherwise, if the quality of the first reference signal exceeds the threshold quality, the terminal device 110 may determine the target period by comprising at least a part of the candidate period.

The terminal device 110 may receive 535 at least a part of the first reference signal from the network device 120 within the target period. Upon receipt of the first reference signal, the terminal device 110 then performs 540 positioning measurements on the first reference signal within the target period. In some example embodiments, the terminal device 110 may receive, in 535, only the part of the first reference signal determined corresponding to the target period, rather than a complete first reference signal.

In some other example embodiments, the terminal device 110 may receive, in 535, the complete first reference signal, and then determine the part of the first reference signal based on the target period.

Upon the determination of the target period, the terminal device 110 performs 540 the positioning measurements (e.g., the ToA/RSTD estimation) on the first reference signal within the target period.

In order to perform the positioning measurements on the target period, the terminal device 110 may determine an updated size of a time-frequency transformation size based on the target period. By way of example, the terminal device 110 may determine a new FFT size based on the target period, for example, by switching from 2048 to 512. Then, the terminal device 110 may perform the positioning measurements based on the updated size of the time-frequency transformation.

The terminal device 110 may transmit 545 the positioning measurements to the LM device 140 for positioning. In the practice, all or a part of the above operations 505 to 540 can be performed repeatedly in one PRS occasion (e.g., in symbol-to-symbol manner) or across more than one PRS occasion (e.g., in a subframe-to-subframe manner).

According to the DL positioning solution provided in the embodiment of the present disclosure, the terminal device is capable of receiving reference signals from different base stations or a combination of base stations with an adaptive receiving window. Comparing with a fixed period of the original receiving window, the period of the adaptive receiving window can be adjusted based on multiple factors, such as, the channel characteristics, the PRS muting pattern, the beam management, and etc. In this way, the impact of the inter-symbol interference at the carrier frequencies can be minimized, and the positioning performance can be improved, while the system complexity is not increased significantly.

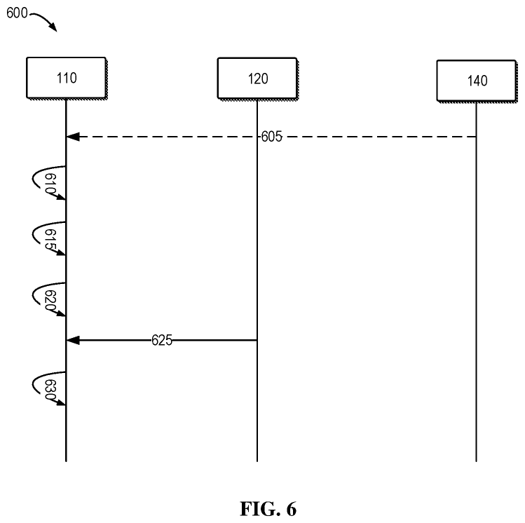

FIG. 6 illustrates a signaling flow 600 for UL-based positioning in accordance with some example embodiments of the present disclosure. The process 600 is provided as one of the implementations in UL of the method 400 shown in FIG. 4. Thus, in the description of the process 600, the first device is the network device that receives and measures the reference signals and the second device is the terminal device that transmits the reference signal. For the purpose of discussion, the process 600 will be described with reference to FIG. 1 in which the network device 120 acts as the first device, and the terminal device 110 acts as the second device. The process 600 may further involve the LM device 140 in FIG. 1.

As shown in FIG. 6, the network device 120 may obtain 605 the positioning assistance data from the LM device 140. The positioning assistance data may include, but not limited to, the location of the network device 120, the location of the network device 130, a distance between the network device 120 and the network device 130.

The network device 120 determines 610 an estimation of a propagation delay for the first reference signal to be transmitted from the terminal device 110. The estimation of the propagation delay may be determined based on a rough distance between the network device 120 and the transmitter of the first reference signal, namely, the terminal device 110. In some example embodiments, the rough distance may be determined based on the prior location of the terminal device 110, for example, in a case where the terminal device 110 is stationary or in low mobility. In addition, or alternatively, the rough distance may be determined based on the positioning assistance data.

The network device 120 determines 615 whether the estimation of the propagation delay exceeds a threshold delay. The threshold delay is configured for determining whether the estimation of the propagation delay is so large that may cause a misalignment of the symbol on which the first reference signal is received and the original receiving window 301 of the terminal device 110. In other words, the threshold delay indicates a tolerance of timing synchronization misalignment between the receiver (i.e., the first device) and the transmitter (i.e., the second device). In some example embodiments, the threshold delay may be determined based on the length of the CP of the symbol or a predefined duration.

If the estimation of the propagation delay exceeds the threshold delay, it may indicate that the terminal device 110 is far away from the network device 120, and the symbol alignment of PRB resources for the first reference signal cannot be reached. In this case, performing measurements (e.g., ToA, and so on) on the original receiving window may lead to a degradation of SNR and a reduction of the positioning accuracy. In some embodiments, if the network device 120 determines that the estimation of the propagation delay exceeds the threshold delay in 615, the network device 120 determines 620 a target period within a symbol on which at least a part of the first reference signal is received. In the context of the present disclosure, the target period may be also referred to a target receiving window.

In some example embodiments, the network device 120 may determine the target period based on one or more of the following factors: the estimation of the propagation delay, a quality of the first reference signal and a comb structure of PRS including the first reference signal in the frequency domain, and so on.

In addition, or alternatively, to determine the target period in 620, the network device 120 may first determine a candidate period within the symbol based on the estimation of the propagation delay and the comb structure of PRSs in the frequency domain. By way of example, the candidate period may be determined by comparing the estimation of the propagation delay and the slot/symbol structure of the serving cell 104. The candidate period corresponds to an effective portion of the first reference signal within an OFDM symbol.

In some example embodiments, the effective portion may be an inter-symbol-interference free portion of the first reference signal within the symbol based on a comb structure of the PRS and the estimation of the propagation delay. The inter-symbol-interference free portion of the first reference signal includes at least one of the time-frequency repetitions in the first reference signal, and each of the repetitions contains all information carried in the first reference signal. In some other example embodiments, the network device 120 may use multiple Fast Fourier Transformations (FFTs) with different repetitions to compare the interference level. It is to be understood that the candidate period may or may not correspond to an integer multiple of the repetitions (e.g., 1.5 repetitions), as long as all the information carried by the first reference signal is included.

After determining the candidate period, the network device 120 may then determine the target period based on the candidate period and the quality of the first reference signal. The quality of the first reference signal may be indicated by a fact that whether the first reference signal is dominated by noise or interference. In some example embodiments, this can be determined from the estimation of the propagation delay. For example, if the estimation of the propagation delay indicates that the terminal device 110 is far away from the network device 120, the first reference signal is very likely to be dominated by noise. Otherwise, if the estimation of the propagation delay indicates that the terminal device 110 is in proximity of the network device 120, the first reference signal may be dominated by interference.

In some other example embodiments, the quality of the first reference signal may be determined based on parameters related to signal quality. Such parameters may include, for example, the reference signal received powers (RSRP) of the PRSs, the reference signal receiving qualities (RSRQ) of the PRSs, the received signal strength indicator (RSSI) of the PRSs, the signal to noise ratios (SNR) of the PRSs.

Still referring to FIG. 6, if the quality of the first reference signal indicates that a noise level dominating in the first reference signal, in 620, the network device 120 may determine the target period by extending the candidate period. In this way, the SNR of the first reference signal is boosted. Otherwise, if the quality of the first reference signal indicates that an interference level dominating in the first reference signal, the network device 120 may consider the candidate period as the target period. In other words, the candidate period is determined to be the target period without any adjustment. It is to be understood that various ways of adjusting the candidate period to determine the target period are suitable to the example embodiments, and thus the scope of the present disclosure is not limited in this aspect.

Alternatively, in some other example, if the quality of the first reference signal is below a threshold quality, the network device 120 may determine the target period by extending the candidate period to receive more repetitions in the symbol. Otherwise, if the quality of the first reference signal exceeds the threshold quality, the network device 120 may determine the candidate period to be the target period.

The network device 120 may receive 625 at least a part of the first reference signal from the terminal device 110 within the target period. Upon receipt of the first reference signal, the network device 120 then performs 630 positioning measurements on the first reference signal within the target period. In some example embodiments, the network device 120 may receive, in 625, only the part of the first reference signal determined corresponding to the target period, rather than a complete first reference signal.

In some other example embodiments, the network device 120 may receive, in 625, the complete first reference signal, and then determine the part of the first reference signal based on the target period.

In order to perform the positioning measurements on the target period, the network device 120 may determine an updated size of a time-frequency transformation size based on the target period. By way of example, the network device 120 may determine a new FFT size based on the target period, for example, by switching from 2048 FFT to 512 FFT. Then, the network device 120 may perform the positioning measurements based on the updated size of the time-frequency transformation.

In the practice, all or a part of the above operations 605 to 625 can be performed repeatedly in one PRS occasion (e.g., in symbol-to-symbol manner) or across more than one PRS occasion (e.g., in a subframe-to-subframe manner).

According to the example embodiments of the present disclosure, there is provided a solution for UL-based positioning. In the solution, the target period of the adaptive receiving window can be adjusted based on several factors, such as, the channel characteristics, PRS muting pattern, beam management, and etc. With such a solution, the impact of the inter-symbol interference at high carrier frequencies can be minimized, and the positioning performance can be improved

In some example embodiments, a first apparatus capable of performing the method 400 may comprise means for performing the respective steps of the method 400. The means may be implemented in any suitable form. For example, the means may be implemented in a circuitry or software module.

In some example embodiments, the first apparatus comprises: means for determining an estimation of a propagation delay for a first reference signal to be transmitted from a second apparatus; means for in accordance with a determination that the estimation of the propagation delay exceeds a threshold delay, determining a target period within a symbol on which at least a part of the first reference signal is transmitted, the threshold delay indicating a tolerance of timing synchronization misalignment between the first apparatus and the second apparatus; and means for performing positioning measurements on the first reference signal within the target period.

In some example embodiments, the first apparatus comprises a terminal device, and the second apparatus comprises a network device providing a neighbor cell of the first apparatus, and the estimation of the propagation delay comprises a time offset of a first receipt time of the first reference signal relative to a second receipt time of a second reference signal from a serving cell of the first apparatus.

In some example embodiments, the estimation of the propagation delay is determined based on a distance between the first apparatus and the second apparatus.

In some example embodiments, the first apparatus comprises a terminal device, the second apparatus comprises a network device providing a neighbor cell of the first apparatus, and a third apparatus comprises a further network device providing a serving cell of the first apparatus, and the distance between the first apparatus and the second apparatus is determined based on at least one of the following: a prior location of the first apparatus, or positioning assistance data comprising at least one of a location of the second apparatus, a location of the third apparatus, a distance between the second apparatus and the third apparatus, a diameter of the serving cell or expected RSTD and uncertainty information.

In some example embodiments, the first apparatus comprises a network device, a third apparatus comprises a further network device providing a neighbor cell of the first apparatus, and the second apparatus comprises a terminal device served by the third apparatus, and the distance between the first apparatus and the second apparatus is determined based on at least one of the following: a comb structure of positioning reference signals, PRSs, in a frequency domain, the PRSs at least comprising the first reference signal; a prior location of the second apparatus, or positioning assistant data comprising at least one of a location of the first apparatus, a location of the third apparatus, a distance between the first apparatus and the third apparatus.

In some example embodiments, the first apparatus comprises a terminal device, and the second apparatus comprises a network device providing a neighbor cell of the first apparatus, and the estimation of the propagation delay is determined based on receiving timing of a further reference signal from the second apparatus.

In some example embodiments, the threshold delay is determined based on one of a length of a cyclic prefix of the symbol or a predefined duration.

In some example embodiments, the target period is determined based on at least one of the estimation of the propagation delay, a quality of the first reference signal and a comb structure of positioning reference signals, PRSs, in a frequency domain, the PRSs at least comprising the first reference signal.

In some example embodiments, the means for determining the target period within the symbol comprises: means for determining a candidate period within the symbol based on the estimation of the propagation delay and a comb structure of positioning reference signals, PRSs, in a frequency domain, the PRSs at least comprising the first reference signal; and means for determining the target period based on the candidate period and a quality of the first reference signal.

In some example embodiments, the means for determining the candidate period comprises: means for determining an effective portion of the first reference signal within the symbol based on the estimation of the propagation delay and the comb structure, the effective portion comprising at least one of repetitions in the first reference signal, each of the repetitions containing all information carried in the first reference signal; and means for determining a first period of the symbol to be the candidate period, the first period of the symbol corresponding to the effective portion.

In some example embodiments, the quality of the first reference signal is determined based on at least one of the following: a parameter related to signal quality comprising one or more of a reference signal received power, a reference signal receiving quality, a received signal strength indicator and a signal to noise ratio of the first reference signal, or a PRS configuration comprising one or more of a muting pattern and a transmitter beam pattern of the second apparatus, a receiver beam pattern of the first apparatus, or quasi co-location information of the first reference signal.

In some example embodiments, the means for determining the target period within the symbol comprises: means for in accordance with a determination that the quality of the first reference signal indicates that a noise level dominating in the first reference signal, determining the target period by extending the candidate period; and means for in accordance with a determination that the quality of the first reference signal indicates that an interference level dominating in the first reference signal, determining the candidate period to be the target period.

In some example embodiments, the means for determining the target period within the symbol comprises: means for in accordance with a determination that the quality of the first reference signal is below a threshold quality, determining the target period by extending the candidate period; and means for in accordance with a determination that the quality of the first reference signal exceeds the threshold quality, determining the candidate period to be the target period.

In some example embodiments, the means for performing positioning measurements within the target period comprises: means for receiving, based on the target period, the part of the first reference signal rather than a complete first reference signal; and means for performing the positioning measurements on the part of the first reference signal.

In some example embodiments, the means for performing positioning measurements within the target period comprises: means for receiving the first reference signal from the second apparatus; means for determining the part of the first reference signal based on the target period; and means for performing the positioning measurements on the part of the first reference signal.

In some example embodiments, the means for performing positioning measurements on the target period comprises: means for determining an updated size of a time-frequency transformation size based on the target period; and means for determining an updated size of a time-frequency transformation size based on the target period.

In some example embodiments, the first apparatus is one of a terminal device and a network device, and the second apparatus is the other one of the terminal device and the network device.

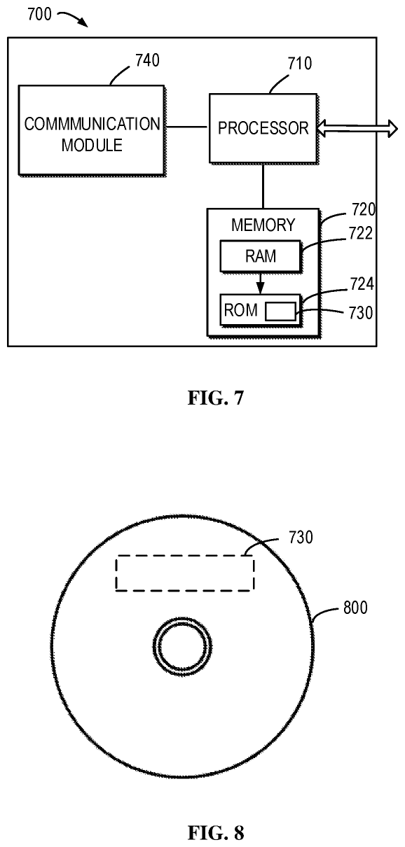

FIG. 7 is a simplified block diagram of a device 700 that is suitable for implementing embodiments of the present disclosure. The device 700 may be provided to implement the communication device, for example the terminal device 110, the network device 120, the network device 130 and the LM device 140, as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 720. The processor 710 may perform any suitable actions and processing by loading the program 730 into the RAM 720.

The embodiments of the present disclosure may be implemented by means of the program 730 so that the device 700 may perform any process of the disclosure as discussed with reference to FIGS. 4 to 6. The embodiments of the present disclosure may also be implemented by hardware or by a combination of software and hardware.

In some embodiments, there is provided a computer program, for example, the program 730 as shown in FIG. 7. The computer program comprises instructions for causing an apparatus to perform at least the following: determining an estimation of a propagation delay for a first reference signal to be transmitted from a second device; in accordance with a determination that the estimation of the propagation delay exceeds a threshold delay, determining a target period within a symbol on which at least a part of the first reference signal is transmitted, the threshold delay indicating a tolerance of timing synchronization misalignment between the apparatus and the second device; and performing positioning measurements on the first reference signal within the target period.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

In some embodiments, there is provided a computer readable medium, for example, the computer readable medium 800 as shown in FIG. 8. The computer readable medium comprises program instructions for causing an apparatus to perform at least the following: determining an estimation of a propagation delay for a first reference signal to be transmitted from a second device; in accordance with a determination that the estimation of the propagation delay exceeds a threshold delay, determining a target period within a symbol on which at least a part of the first reference signal is transmitted, the threshold delay indicating a tolerance of timing synchronization misalignment between the apparatus and the second device; and performing positioning measurements on the first reference signal within the target period.

In some embodiments, there is provided a non-transitory computer readable medium comprising program instructions for causing an apparatus to perform at least the following: determining an estimation of a propagation delay for a first reference signal to be transmitted from a second device; in accordance with a determination that the estimation of the propagation delay exceeds a threshold delay, determining a target period within a symbol on which at least a part of the first reference signal is transmitted, the threshold delay indicating a tolerance of timing synchronization misalignment between the apparatus and the second device; and performing positioning measurements on the first reference signal within the target period

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 as described above with reference to FIG. 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

I claim:

1. A first device comprising:
at least one processor; and
at least one memory
storing instructions that, when executed by the at least one processor, cause the first device to:
determine an estimation of a propagation delay for a first reference signal to be transmitted from a second device;
in accordance with a determination that the estimation of the propagation delay exceeds a threshold delay, determine a target period within a symbol on which at least a part of the first reference signal is transmitted, the threshold delay indicating a tolerance of timing synchronization misalignment between the first device and the second device; and
perform positioning measurements on the first reference signal within the target period.

2. The first device of claim 1, wherein the first device comprises a terminal device, and the second device comprises a network device providing a neighbor cell of the first device, and wherein the estimation of the propagation delay comprises a time offset of a first receipt time of the first reference signal relative to a second receipt time of a second reference signal from a serving cell of the first device.

3. The first device of claim 1, wherein the estimation of the propagation delay is determined based on a distance between the first device and the second device.

4. The first device of claim 3, wherein the first device comprises a terminal device, the second device comprises a network device providing a neighbor cell of the first device, and a third device comprises a further network device providing a serving cell of the first device, and wherein the distance between the first device and the second device is determined based on at least one of the following:
a prior location of the first device, or
positioning assistance data comprising at least one of a location of the second device, a location of the third device, a distance between the second device and the third device, a diameter of the serving cell or expected RSTD and uncertainty information.

5. The first device of claim 3, wherein the first device comprises a network device, a third device comprises a further network device providing a neighbor cell of the first device, and the second device comprises a terminal device served by the third device, and wherein the distance between the first device and the second device is determined based on at least one of the following:
a prior location of the second device, or
positioning assistance data comprising at least one of a location of the first device, a location of the third device, a distance between the first device and the third device.

6. The first device of claim 1, wherein the first device comprises a terminal device, and the second device comprises a network device providing a neighbor cell of the first device, and wherein the estimation of the propagation delay is determined based on receiving timing of a further reference signal from the second device.

7. The first device of claim 1, wherein the threshold delay is determined based on one of a length of a cyclic prefix of the symbol or a predefined duration.

8. The first device of claim 1, wherein the target period is determined based on at least one of the estimation of the propagation delay, a quality of the first reference signal and a comb structure of positioning reference signals, PRSs, in a frequency domain, the PRSs at least comprising the first reference signal.

9. The first device of claim 1, wherein the first device is caused to determine the target period within the symbol by:
determining a candidate period within the symbol based on the estimation of the propagation delay and a comb structure of positioning reference signals, PRSs, in a frequency domain, the PRSs at least comprising the first reference signal; and
determining the target period based on the candidate period and a quality of the first reference signal.

10. The first device of claim 9, wherein the first device is caused to determine the candidate period by:
determining an effective portion of the first reference signal within the symbol based on the estimation of the propagation delay and the comb structure, the effective portion comprising at least one of repetitions in the first reference signal, each of the repetitions containing all information carried in the first reference signal; and
determining a first period of the symbol to be the candidate period, the first period of the symbol corresponding to the effective portion.

11. The first device of claim 9, wherein the quality of the first reference signal is determined based on at least one of the following:
a parameter related to signal quality comprising one or more of a reference signal received power, a reference signal receiving quality, a received signal strength indicator and a signal to noise ratio of the first reference signal, or
a PRS configuration comprising one or more of a muting pattern and a transmitter beam pattern of the second device, a receiver beam pattern of the first device, or quasi co-location information of the first reference signal.

12. The first device of claim 9, wherein the first device is caused to determine the target period within the symbol by:
in accordance with a determination that the quality of the first reference signal indicates a noise level dominating in the first reference signal, determining the target period by extending the candidate period; and
in accordance with a determination that the quality of the first reference signal indicates an interference level dominating in the first reference signal, determining the target period by comprising at least a part of the candidate period.

13. The first device of claim 9, wherein the first device is caused to determine the target period within the symbol by:
in accordance with a determination that the quality of the first reference signal is below a threshold quality, determining the target period by extending the candidate period; and
in accordance with a determination that the quality of the first reference signal exceeds the threshold quality, determining the target period by comprising at least a part of candidate period.

14. The first device of claim 1, wherein the first device is caused to perform positioning measurements within the target period by:
receiving, based on the target period, the part of the first reference signal rather than a complete first reference signal; and
performing the positioning measurements on the part of the first reference signal.

15. The first device of claim 1, wherein the first device is caused to perform positioning measurements within the target period by:
receiving the first reference signal from the second device;
determining the part of the first reference signal based on the target period; and
performing the positioning measurements on the part of the first reference signal.

16. The first device of claim 1, wherein the first device is caused to perform positioning measurements on the target period by:
determining an updated size of a time-frequency transformation size based on the target period; and
performing the positioning measurements based on the updated size of the time-frequency transformation.

17. The first device of claim 1, wherein the first device is one of a terminal device and a network device, and the second device is the other one of the terminal device and the network device.

18. A method of communications, comprising:
determining, by a first device, an estimation of a propagation delay for a first reference signal to be transmitted from a second device;
in accordance with a determination that the estimation of the propagation delay exceeds a threshold delay, determining a target period within a symbol on which at least a part of the first reference signal is transmitted, the threshold delay indicating a tolerance of timing synchronization misalignment between the first device and the second device; and
performing positioning measurements on the first reference signal within the target period.

19. The method of claim 18, wherein the first device comprises a terminal device, and the second device comprises a network device providing a neighbor cell of the first device, and wherein the estimation of the propagation delay comprises a time offset of a first receipt time of the first reference signal relative to a second receipt time of a second reference signal from a serving cell of the first device.

20.-36. (canceled)

37. A non-transitory computer readable medium comprising program instructions that, when executed by an apparatus, cause the apparatus to perform at least the following:
determining an estimation of a propagation delay for a first reference signal to be transmitted from a second device;
in accordance with a determination that the estimation of the propagation delay exceeds a threshold delay, determining a target period within a symbol on which at least a part of the first reference signal is transmitted, the threshold delay indicating a tolerance of timing synchronization misalignment between the apparatus and the second device; and
performing positioning measurements on the first reference signal within the target period.
